(19) United States
(12) Patent Application Publication
(10) Pub. No.: US 2003/0193310 A1
(43) Pub. Date: Oct. 16, 2003

(54) DIAGNOSTIC METHOD FOR AN ELECTRIC MOTOR USING TORQUE ESTIMATES

(75) Inventors: Abbas Raftari, Northville, MI (US); Matthew A. Boesch, Plymouth, MI (US); Vijay K. Garg, Canton, MI (US)

Correspondence Address: BROOKS & KUSHMAN P.C./FGTL, 1000 TOWN CENTER, 22ND FLOOR, SOUTHFIELD, MI, 48075, US

(73) Assignee: Ford Motor Company, Dearborn, MI

(21) Appl. No.: 10/063,345

(22) Filed: Apr. 12, 2002

(51) Int. Cl. H02P 5/28

(52) U.S. Cl. 318/798

(57) ABSTRACT

The present invention can diagnose a potential fault in an electric motor by generating two independent torque estimates using a plurality of current sensors and optionally a shaft position sensor. The invention provides a strategy to generate two independent torque estimates of a three phase electric motor comprising first and second systems to determine current in each motor phase, first and second systems to generate a first and second estimate of motor shaft position, and first and second systems to generate first and second estimates of motor torque using the first and second systems to determine current in each motor phase and the first and second estimates of motor shaft position. The present invention detects a fault in an electric motor propelled vehicle's electrical components and sub-systems, including single subsystem failures system based on discrepancies between to the two independent torque estimates.

### BACKGROUND OF INVENTION

The present invention relates generally to an electrically powered vehicle, such as an electric vehicle (EV), a hybrid electric vehicle (HEV) or a fuel cell vehicle (FCV). More specifically the invention relates to a strategy to diagnose a potential fault in an electric motor. The present invention can determine two independent electric motor torque estimates using a plurality of current transducers and optionally a shaft position sensor for the traction motor.

The need to reduce fossil fuel consumption and emissions in automobiles and other vehicles predominately powered by internal combustion engines (ICEs) is well known. Vehicles powered by electric motors attempt to address these needs. Another alternative solution is to combine a smaller ICE with electric motors into one vehicle. Such vehicles combine the advantages of an ICE vehicle and an electric vehicle and are typically called hybrid electric vehicles (HEVs). See generally, U.S. Pat. No. 5,343,970 to Severinsky.

The HEV is described in a variety of configurations. Many HEV patents disclose systems where an operator is required to select between electric and internal combustion operation. In other configurations, the electric motor drives one set of wheels and the ICE drives a different set.

Other, more useful, configurations have developed. For example, a series hybrid electric vehicle (SHEV) configuration is a vehicle with an engine (most typically an ICE) connected to an electric motor called a generator. The generator, in turn, provides electricity to a battery and another motor, called a traction motor. In the SHEV, the traction motor is the sole source of wheel torque. There is no mechanical connection between the engine and the drive wheels. A parallel hybrid electrical vehicle (PHEV) configuration has an engine (most typically an ICE) and an electric motor that work together in varying degrees to provide the necessary wheel torque to drive the vehicle. Additionally, in the PHEV configuration, the motor can be used as a generator to charge the battery from the power produced by the ICE.

A parallel/series hybrid electric vehicle (PSHEV) has characteristics of both PHEV and SHEV configurations and is sometimes referred to as a “powersplit” configuration. In one of several types of PSHEV configurations, the ICE is mechanically coupled to two electric motors in a planetary gear-set transaxle. A first electric motor, the generator, is connected to a sun gear. The ICE is connected to a carrier gear. A second electric motor, a traction motor, is connected to a ring (output) gear via additional gearing in a transaxle. Engine torque can power the generator to charge the battery. The generator can also contribute to the necessary wheel (output shaft) torque if the system has a one-way clutch. The traction motor is used to contribute wheel torque and to recover braking energy to charge the battery. In this configuration, the generator can selectively provide a reaction torque that may be used to control engine speed. In fact, the engine, generator motor and traction motor can provide a continuous variable transmission (CVT) effect. Further, the HEV presents an opportunity to better control engine idle speed over conventional vehicles by using the generator to control engine speed.

The desirability of combining an ICE with electric motors is clear. There is great potential for reducing vehicle fuel consumption and emissions with no appreciable loss of vehicle performance or drive-ability. The HEV allows the use of smaller engines, regenerative braking, electric boost, and even operating the vehicle with the engine shutdown. Nevertheless, new ways must be developed to optimize the HEV's potential benefits.

One such area of development is calculating torque estimates delivered by an electric motor or motors. An effective and successful HEV design (or any vehicle powertrain propelled by electric motors and optionally capturing regenerative braking energy) requires reliable operation. Reliable operation can be improved through careful diagnosis of potential faults within the electric motor or motors. Thus there is a need for a strategy to effectively detect fault in an electric motor propelled vehicle's electrical components and sub-systems, including single subsystem failures, specifically, within the vehicles electric motors. One way to detect fault in an electric motor is to compare two independent calculations of motor torque.

Previous efforts have used rotor position sensors or estimates as part of the control strategy for an electric motor. For example, Jones et al. (U.S. Pat. No. 6,211,633) discloses an apparatus for detecting an operating condition of a machine synchronizes sampling instants with the machine condition so that reliability data are obtained. The operating condition may be the position of the rotor in which case estimates of the rotor position and rotor velocity at each of the sampling instants are developed.

Lyons et al. (U.S. Pat. No. 5,864,21 7) discloses an apparatus and method for estimating rotor position in and commutating a switched reluctance motor (SRM), using both flux/current SRM angle estimator and a toothed wheel generating a magnetic pickup. Phase errors can be compensated by adjusting the angle input to the commutator as a function of estimated speed. Alternately, the flux/current SRM angle estimator can be run in background mode to tune the toothed wheel interrupt angle signal at different speeds.

Drager et al. (U.S. Pat. No. 5,867,004) discloses a control for operating an inverter coupled to a switched reluctance machine that includes a relative angle estimation circuit for estimating rotor angle for a phase in the switched reluctance machine.

Lyons et al. (U.S. Pat. No. 5,107,195) discloses a method and apparatus for indirectly determining rotor position in a switched reluctance motor that are based on a flux/current model of the machine, which model includes multi-phase saturation, leakage, and mutual coupling effects.

Lastly, Acarnley (U.S. Pat. No. 6,005,364) discloses a motor monitoring and control circuit that calculates a value parameter for a position of the motor at given instants. The same parameter (which may be position or speed of a rotor) is then measured at subsequent instants. These values are used to compute a future value of the parameter.

The use of two independent torque estimates to diagnose a potential fault in the electric motor of an electric motor propelled vehicle is unknown in the prior art.

### SUMMARY OF INVENTION

Accordingly, the present invention provides a strategy to effectively detect fault in an electric motor propelled vehicle's electrical components and sub-systems, including single subsystem failures of the electric motor by creating two independent torque estimates of an electric motor for a hybrid electric vehicle (HEV) using a plurality of current transducers and optionally a shaft position sensor. Discrepancies between the two independent torque estimates or the signals used to create the two independent torque estimates can be indicative of a fault or a system or a subsystem failure such as stray current leakage.

More specifically, the invention provides a strategy to generate two independent torque estimates of a three phase electric motor comprising first and second systems to determine current in each motor phase, first and second systems to generate a first and second estimate of motor shaft position, and first and second systems to generate first and second estimates of motor torque using the first and second systems to determine current in each motor phase and the first and second estimates of motor shaft position.

The strategy uses four current sensors to generate four measured currents, which are used for the first and second systems to determine current in each motor phase. The first and second systems to estimate motor shaft position can be Kalman filters. Alternatively the second system to estimate motor shaft position can be a resolver.

Other objects of the present invention will become more apparent to persons having ordinary skill in the art to which the present invention pertains from the following description taken in conjunction with the accompanying figures.

### BRIEF DESCRIPTION OF DRAWINGS

The foregoing objects, advantages, and features, as well as other objects and advantages, will become apparent with reference to the description and figures below, in which like numerals represent like elements and in which:

FIG. 1 illustrates a general hybrid electric vehicle (HEV) configuration.

FIG. 2 illustrates an electric traction motor for an HEV.

FIG. 3 illustrates electric motor stator windings connected in a “wye” configuration.

FIG. 4 illustrates an arrangement of four current sensors having two sensors in each of two phases.

FIG. 5 illustrates an alternate arrangement of four current sensors.

FIG. 6 illustrates the strategy of the present invention in block diagram form.

### DETAILED DESCRIPTION

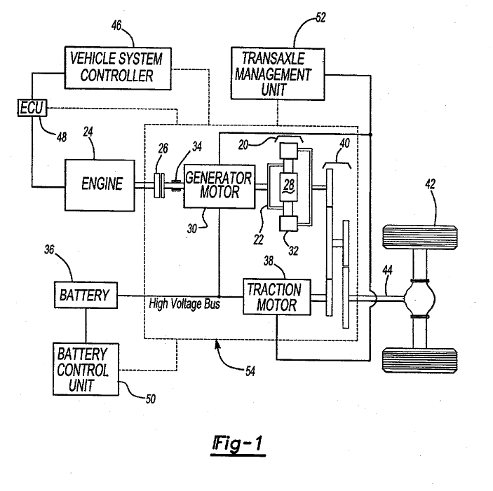

The present invention relates to electric motors. As the use of electric motors in vehicle applications increases, motor reliability potential fault detection becomes critical. This is especially true in the harsh conditions typically experienced by motors used as vehicle components. For demonstration purposes and to assist in understanding the present invention, it is described in an hybrid electric vehicle (HEV) application. FIG. 1 demonstrates just one possible HEV configuration, specifically a parallel/series hybrid electric vehicle (powersplit) configuration.

In a basic HEV, a planetary gear set 20 mechanically couples a carrier gear 22 to an engine 24 via a one-way clutch 26. The planetary gear set 20 also mechanically couples a sun gear 28 to a generator motor 30 and a ring (output) gear 32. The generator motor 30 also mechanically links to a generator brake 34 and is electrically linked to a battery 36. A traction motor 38 is mechanically coupled to the ring gear 32 of the planetary gear set 20 via a second gear set 40 and is electrically linked to the battery 36. The ring gear 32 of the planetary gear set 20 and the traction motor 38 are mechanically coupled to drive wheels 42 via an output shaft 44.

The planetary gear set 20, splits the engine 24 output energy into a series path from the engine 24 to the generator motor 30 and a parallel path from the engine 24 to the drive wheels 42. Engine 24 speed can be controlled by varying the split to the series path while maintaining the mechanical connection through the parallel path. The traction motor 38 augments the engine 24 power to the drive wheels 42 on the parallel path through the second gear set 40. The traction motor 38 also provides the opportunity to use energy directly from the series path, essentially running off power created by the generator motor 30. This reduces losses associated with converting energy into and out of chemical energy in the battery 36 and allows all engine 24 energy, minus conversion losses, to reach the drive wheels 42.

A vehicle system controller (VSC) 46 controls many components in this HEV configuration by connecting to each component's controller. An engine control unit (ECU) 48 connects to the engine 24 via a hardwire interface. All vehicle controllers can be physically combined in any combination or can stand as separate units. They are described as separate units here because they each have distinct functionality. The VSC 46 communicates with the ECU 48, as well as a battery control unit (BCU) 50 and a transaxle management unit (TMU) 52 through a communication network such as a controller area network (CAN) 54. The BCU 50 connects to the battery 36 via a hardwire interface. The TMU 52 controls the generator motor 30 and traction motor 38 via a hardwire interface.

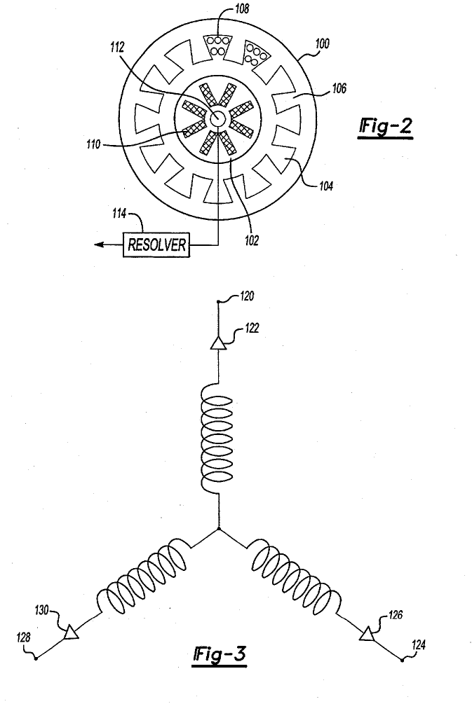

A basic diagram of the traction motor 38 is illustrated in FIG. 2. The traction motor 38 has a stator 100, having slots 104 and teeth 106. Motor windings 108 carry electric current through the traction motor 38. The windings are connected in a “wye” configuration, as illustrated in FIG. 3, below. Interior to stator is the rotor 102. The illustrated rotor 102 has permanent interior magnets 110. The motor shaft 112 passes through the rotor 102. A resolver 114 can be connected to the motor shaft 112.

The windings 108 of a three phase electric motor can be represented as being arranged in a “wye.” Each of the three phases, commonly referred to as phase a, b, and c are represented by one leg of the “wye.” The “wye” configuration is illustrated in FIG. 3. Phase a 120 would have a corresponding electric current, current a (Iₐ) 122, passing through it. Similarly, phases b 124 and c 128 would have corresponding electric currents, current b (I_{b}) 126 and current c (I_{c}) 130, respectively passing through them as well. Measurement or estimation of all three motor phase currents (122, 126, and 130) and the motor shaft 112 position angle is required to calculate the motor torque.

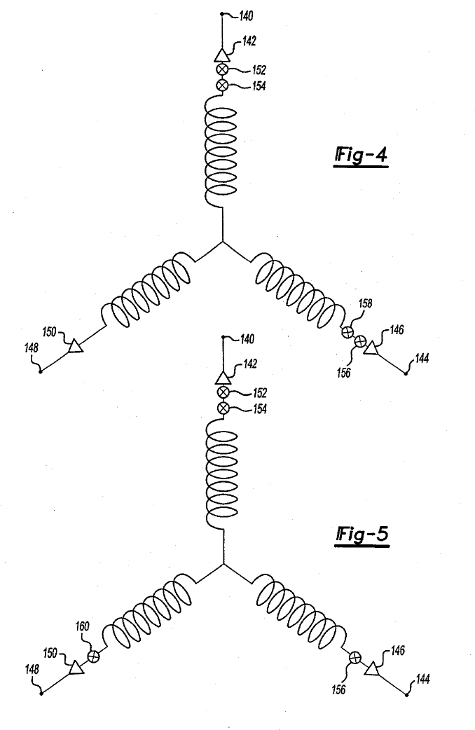

In the present invention the VSC 46 can detect single system faults generally by two procedures (shown in FIGS. 4 and 5) using alternate types of independent estimations of machine torque. For the embodiments presented, four current sensors per electric motor are used. Many other types of configurations are possible. Sensor output can be sent to the VSC 46 where appropriate actions may be taken such as lighting an indicator lamp or sounding an indicator tone to warn the operator of a potential system fault. Additionally, other hazard mitigation steps, known in the art, could be employed such as cutting power to the motor 38.

FIG. 4 shows a first embodiment of the present invention. FIG. 4, like FIG. 3, shows the “wye” configuration of the three phases of the electric motor. In practice, any individual leg of the “wye” can be any of the individual phases. In FIG. 4, the phases will be referred to as phases x, y, and z, where phases x, y, and z can be any ordering of phases a, b, or c. Phase x 140 would have a corresponding electric current, current x (Iₓ) 142, passing through it. Similarly, phases y 144 and z 148 would have corresponding electric currents, current y (I_{y}) 146 and current z (I_{z}) 150, respectively passing through them as well.

Added to the “wye” configuration are four current sensors. The first current sensor 152 gives a measured current x (iₓ). The second current sensor 154 gives a second measured current x (iₓ′). The third current sensor 156 gives a measured current y (i_{y}). The fourth current sensor 158 gives a second measured current y (i_{y}′). These sensors can be of any type known in the art for measuring motor phase current, such as a resistive shunt or non-contacting current transducers and can be either active or passive.

FIG. 5 shows an alternate arrangement of four current sensors on the legs of the “wye” configuration representing the phase s of the electric motor. In this embodiment the first current sensor 152 gives a measured current x (iₓ). The second current sensor 154 gives a second measured current x (iₓ′). The third current sensor 156 gives a measured current y (i_{y}). The fourth current sensor 160 gives a measured current z (iₓ′).

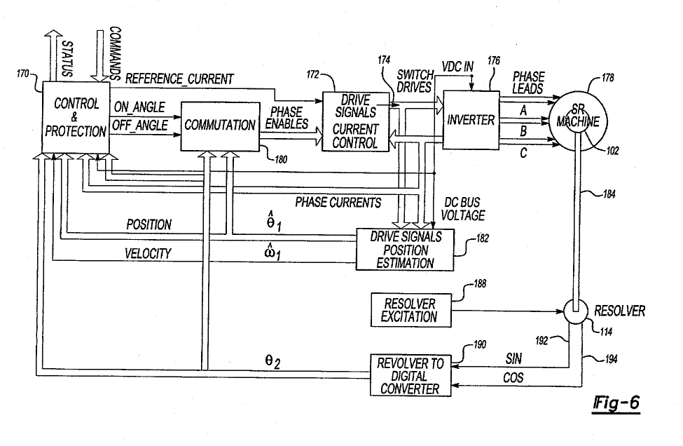

FIG. 6 illustrates a possible strategy using the present invention in block diagram form. An inverter control for operating a switched reluctance machine 178 includes the resolver 114 coupled by a motive power shaft 184 to the rotor 102 of the switched reluctance machine 178. Excitation is provided by a resolver excitation circuit 188. The resolver 114 develops first and second signals over lines 192 and 194 that have a phase quadrature relationship (also referred to as sine and cosine signals). A resolver-to-digital converter 190 is responsive to the magnitudes of the signals on the lines 192 and 194 and develops a digital output representing the position of the rotor 102 of the switched reluctance machine 178. The position signals are supplied along with a signal representing machine rotor 102 velocity to a control and protection circuit 170. The rotor 102 position signals are also supplied to a commutation circuit 180 and a current control circuit 172 having an input coupled to an output of the control and protection circuit 170. Circuits 170 and 172 further receive phase current magnitude signals as developed by an inverter 176. The circuits 170 and 172 develop switch drive signals on lines 174 for the inverter 176 so that the phase currents flowing in the windings of the switched reluctance machine 178 are properly commutated. A position estimation circuit or subsystem 182 is responsive to the phase current magnitudes developed by the inverter 176, switch control or drive signals for switches in the inverter 176 and DC bus voltage magnitude to develop position and velocity estimate signals for the control and protection circuit 170. In addition, the position estimate signals are supplied to the commutation circuit 180. The current control circuit 172 is responsive to the phase current magnitudes developed by the inverter 176, as well as phase enable output signals developed by the commutation circuit 180 and a reference current signal developed by the control and protection circuit 170. The current control circuit 172 produces the switch control or drive signals on lines 174 for the inverter 176. Measurements from these systems allow the development of strategies to estimate normal traction motor 38 torque.

The resolver 114, known in the prior art, is a direct measurement of rotor 102 position angle. A Kalman filter based estimation method, also known in the art, can generate a second independent calculation of the rotor 102 position angle in electric and hybrid-electric vehicles.

Currents a 122, b 126, and c 130 in the three phases of the “wye” {a 120, b 124, and c 128} are actively switched at high frequency by the three phase inverter 176 between the motor windings 108 and a direct current voltage source, such as the battery 36.

The traction motor 38 has the ideal torque “T” characteristic as follows:

Equation 1:

$$T = \frac{3}{4} p [ {MI}_{f} {I}_{q} + ( {L}_{d} - {L}_{q} ) {I}_{d} {I}_{q} ]$$

where

p is the number of motor poles (known),

M is the rotor to stator mutual inductance (known),

I_{f} is the “equivalent” current corresponding to the permanent magnet magnetic flux (known),

L_{d} is the direct axis inductance (known),

L_{q} is the quadrature axis inductance (known),

I_{d} is the “direct” axis current (estimated from measured and other values), and

I_{q} is the “quadrature” axis current (estimated from measured and other values).

To generate relative currents {I_{d}, I_{q}} in a frame that rotates at the rotor velocity, we can write:

Equation 2:

$${I}_{d} = \frac{2}{3} [ {I}_{a} cos θ + {I}_{b} cos ( θ - γ ) + {I}_{c} cos ( θ + γ ) ]$$

Equation 3:

$${I}_{q} = - \frac{2}{3} [ {I}_{a} sin θ + {I}_{b} sin ( θ - γ ) + {I}_{c} sin ( θ + γ ) ]$$

where:

Iₐ, I_{b}, I_{c} are the stator “wye” coil currents 122, 126, and 130,

θ is the rotor position angle, and

γ is the electrical phase angle between stator coils, and

where:

$$γ = \frac{2}{3} π = 120 deg .$$

To generate two independent estimates of electrical machine torque by using Equation 1, two independent ways to find I_{d}, and I_{q} are required. These currents in turn each depend upon two signals sets:

1. the “wye” connected stator phase coil currents {Iₐ 122, I_{b} 126, I_{c} 130}, and

2. the motor shaft 112 position angle θ.

At least two independent strategies are described to independently estimate each of these two signal sets. For the first strategy, assume each of the three legs of the stator coil has current flowing in that leg. The machine winding neutral at the center of the “wye” is not connected, which is true for the case of inverter driven motors. Because Kirchoff's current law, known to those skilled in the art, applies to the “wye” connected circuit, the currents {Iₐ 122, I_{b} 126, I_{c} 130} obey the relationship:

Equation 4:

Iₐ+I_{b}+I_{c}=0.

Only two currents need to be known to estimate the third current.

For example, if {iₐ, i_{b}, i_{c}} represent current sensor outputs measuring the currents {Iₐ 122, I_{b} 126, I_{c} 130}, by measuring any two, for example {iₐ, i_{b}}, we can estimate the third i_{c} as Equation 5:

î_{c}=−(iₐ+i_{b})

where î_{c} represents an estimated, not measured, output signal. By using two current sensors, we have estimated the three phase stator currents as {iₐ, i_{b}, î_{c}}.

To generate a redundant and completely independent second strategy to estimate stator currents, we cannot rely on either sensor indicating {iₐ, i_{b}}. Instead we can redundantly measure {iₐ, i_{b}} with two additional sensors {iₐ′, i_{b}′} as in FIG. 4, and apply Equation 5 to generate the second estimate of i_{c}′ as:

î_{c}′=−(iₐ′+i_{c}′),

Alternatively, we might choose to measure i_{c}′ directly as in FIG. 5, and either of {iₐ′, i_{b}′} directly, then apply Equation 5 to estimate the remaining current such as:

î_{b}′=−(iₐ′+i_{c}′),

or

îₐ′=−(i_{b}′+i_{c}′).

This dual stator current estimation is summarized in Table 1, where {x, y, z} are any ordering of the stator coils {a, b, c}.

TABLE 1
Altemate Ways to Estimate One of the Three Stator Currents

| | Independent | Independent Strategy | | |
|---|---|---|---|---|
| | Strategy 1: Use | 2: Use any column | | |
| Actual | sensors and | of sensors | | |
| Current | estimators | and estimators | | |
| Iₓ 142 | iₓ | iₓ′ | iₓ′ | −(i_{y}′ + i_{z}′) |
| I_{y} 146 | i_{y} | i_{y}′ | −(iₓ′ + i_{z}′) | i_{y}′ |
| I_{z} 150 | −(iₓ 30 i_{y}) | −(iₓ′ + i_{y}′) | i_{z}′ | i_{z}′ |

Referring to the table, the far left column of Independent Strategy 2 redundantly measures the same two phase currents {x 142, y 146} as does Independent Strategy 1. Putting two current sensors in the same leg may simplify the sensor packaging if two sensors, {x 152, x′ 154} for example, can share any of their non-critical components. Such non-critical components can include passive parts such as a sensor housing, mounting fasteners, ferrite core and electrical connector housing. In this case, Equation 4 can be validated as Equation 7 as follows:

iₓ+i_{y}+−(iₓ′+i_{y}′)=0.

Furthermore, sensors in the same leg can be cross-checked as Equation 8 as follows:

(iₓ−iₓ′)=0,

(i_{y}−i_{y}′)=0.

Any stray current leakage in coil c (due to short circuit faults in wiring to the coil, the coil drivers, and between the coil windings and the stator core) is not explicitly sensed.

Alternatively, the right two columns of Independent Strategy 2 redundantly measure only one of the two phase currents Iₓ 142 or I_{y} 146 as measured in Independent Strategy 1. The other phase current I_{z} 150, has a separate sensor 160 to generate signal i_{z}′, resulting in three unique signals {iₓ, i_{y}, i_{z}′} to verify Equation 4 as Equation 9 as follows:

iₓi_{y}+i_{z}′=0.

If either of the last two columns in the table are selected, any stray current leakage in stator coil c is explicitly sensed, which may enable detection of additional faults causing current leakage in stator coil c.

In using a total of four current sensors on two or three legs of the traction motor's “wye” windings as in FIGS. 4 and 5, all three current measurements can be generated in two independent ways, and cross-checked to detect whether any one or more measurements should be faulted.

All present inverter motor control technologies require the rotor 102 position θ according to Equations 2 and 3. Motor shaft 112 angle θ can be measured directly by a sensor called the resolver 114, or estimated using an observer or Kalman filter based upon the measured motor currents.

An alternate embodiment of the present invention adds the resolver 114 to the embodiment described above. Traditionally, inverter torque motor controls use the resolver 114, composed of a “toothed” ring consisting of a plurality of teeth rotating with the motor shaft 112 being measured, and one or more stationery “tooth” sensors of some technology, be it optical, variable reluctance, Hall effect, or other technology known in the art. If one “toothed” ring and one sensor are used, the resolver 114 is also called a “tone wheel.” The tone wheel measures relative position, and it is not capable of sensing direction of travel. Some “tone wheels” omit a tooth as a reference absolute position, but measurement is only relative, so measurement during changes of direction is impossible. If two “tooth” sensors are used, the resolver 114 can sense direction, but it still cannot measure absolute position. If more than two “tooth” sensors are used, the resolver 114 can sense direction and absolute position. Some drawbacks of resolvers are their expense, high failure rates, and requirement of a high speed interface at the microprocessor that receives their output signals.

Methods have been developed to estimate the motor shaft 112 position. The estimate being derived not from a resolver 114, but from implicit characteristics of the motor. One such characteristic of an inductance motor is the mutual inductance between the stator coils and the induced current in the rotor 102, which is dependent upon the relative angle between the two and can be estimated from the motor phase currents {Iₐ 122, I_{b} 126, I_{c} 130}. Another characteristic that can be used to estimate motor shaft 112 position is the back EMF of the motor, known to those skilled in the art as a voltage across the coil that increases with motor speed.

There are well-documented methods that capitalize on these position dependent motor characteristics to estimate the motor shaft 112 relative position. One method is an observer. Another method is a special case of observer called a Kalman filter. In general the observer will compute by Equation 10:

\hat{θ}=F(s)(Iₐ, I_{b}, I_{c})

where F(s) is the observer transfer function.

To generate separate and independent estimates a of motor shaft 112 position, generate a first estimate using the stator current estimation approach Independent Strategy 1 given above, and a second estimate using the Independent Strategy 2. The combined current and motor shaft 112 position measuring method can detect all single point failures and is robust in that it can enable safe, if not complete, operation even when a single point fault occurs and is detected.

Alternatively, one independent motor shaft 112 angle may be measured with a resolver 114, and a second independent motor shaft 112 angle may be estimated using the proposed observer or Kalman filter and either of the phase current measuring proposals.

The above-described embodiments of the invention are provided purely for purposes of example. Many other variations, modifications, and applications of the invention may be made.

1. A system to diagnose potential fault in a three phase electric motor comprising:
a first system to determine current in each motor phase;
a system to generate a first estimate of motor shaft position;
a system to generate a first estimate of motor torque using the first system to determine current in each motor phase and the first estimate of motor shaft position;
a second system to determine current in each motor phase;
a system to generate a second estimate of motor shaft position;
a system to generate a second estimate of motor torque using the second system to determine current in each motor phase and the second estimate of motor shaft position; and
a system to compare the first and second estimates of motor torque.

2. The system according to claim 1, further comprising a system to notify a motor operator of a potential fault.

3. The system according to claim 1, wherein the first system to determine current in each motor phase comprises:
a first current sensor generating a first measured current of a first phase of the electric motor;
a second current sensor generating a first measured current of a second phase of the electric motor; and
a system to generate a first estimated current of current in a third phase of the electric motor based on the first measured current of the first phase and the first measured current of the second phase.

4. The system according to claim 1, wherein the system to generate the first estimate of motor shaft position is a first Kalman filter.

5. The system according to claim 1, wherein the second system to determine current in each motor phase comprises:
a third current sensor generating a second measured current of a first phase of the electric motor;
a fourth current sensor generating a second measured current of a second phase of the electric motor; and
a system to generate a second estimated current of current in a third phase of the electric motor based on the second measured current of the first phase and the second measured current of the second phase.

6. The system according to claim 1, wherein the second system to determine current in each motor phase comprises:
a third current sensor generating a second measured current of a first phase of the electric motor;
a fourth current sensor generating a first measured current of a third phase of the electric motor; and
a system to generate an estimated current of current in the second phase of the electric motor based on the second measured current of the first phase and the first measured current of the third phase.

7. The system according to claim 1 wherein the system to generate the second estimate of motor shaft position is a second Kalman filter.

8. The system of claim 1 wherein the system to generate the second estimate of motor shaft position is a resolver.

9. A method to diagnose potential fault in a three phase electric motor comprising the steps of:
determining current in each motor phase with a first system;
generating a first estimate of motor shaft position;
generating a first estimate of motor torque using the first system to determine current in each motor phase and the first estimate of motor shaft position;
determining current in each motor phase with a second system;
generating a second estimate of motor shaft position;
generating a second estimate of motor torque using the second system to determine current in each motor phase and the second estimate of motor shaft position; and
comparing the first and second estimates of motor torque.

10. The method according to claim 9, further comprising the step of notifying a motor operator of a potential fault.

11. The method according to claim 9, wherein the step of determining current in each motor phase with a first system comprises:
generating a first measured current of a first phase of the electric motor with a first current sensor;
generating a first measured current of a second phase of the electric motor with a second current sensor; and
generating a first estimated current of current in a third phase of the electric motor based on the first measured current of the first phase and the first measured current of the second phase.

12. The method according to claim 9, wherein the step of generating a first estimate of motor shaft position is accomplished by using a first Kalman filter.

13. The method according to claim 9, wherein the step of determining current in each motor phase with a second system comprises:
generating a second measured current of a first phase of the electric motor with a third current sensor;
generating a second measured current of a second phase of the electric motor with a fourth current sensor; and
generating a second estimated current of current in a third phase of the electric motor based on the second measured current of the first phase and the second measured current of the second phase.

14. The method according to claim 9, wherein the step of determining current in each motor phase with a second system comprises:
generating a second measured current of a first phase of the electric motor with a third current sensor;
generating a first measured current of a third phase of the electric motor with a fourth current sensor; and
generate an estimated current of current in the second phase of the electric motor based on the second measured current of the first phase and the first measured current of the third phase.

15. The method according to claim 9, wherein the step of generating a second estimate of motor shaft position is accomplished by using a second Kalman filter.

16. The method according to claim 9, wherein the step of generating a second estimate of motor shaft position is accomplished by using a resolver.

17. An article of manufacture for diagnosing potential fault in a three phase electric motor comprising:
a controller; and
a control system embodied within the controller for directing the controller to control the steps of determining current in each motor phase with a first system, generating a first estimate of motor shaft position, generating a first estimate of motor torque using the first system to determine current in each motor phase and the first estimate of motor shaft position, determining current in each motor phase with a second system, generating a second estimate of motor shaft position, generating a second estimate of motor torque using the second system to determine current in each motor phase and the second estimate of motor shaft position, comparing the first and second estimates of motor torque for discrepancies, and notifying a motor operator of a potential fault.

18. An automotive vehicle comprising:
a three phase electric motor;
a controller; and
a control system embodied within the controller for directing the controller to control the steps of determining current in each motor phase with a first system, generating a first estimate of motor shaft position, generating a first estimate of motor torque using the first system to determine current in each motor phase and the first estimate of motor shaft position, determining current in each motor phase with a second system, generating a second estimate of motor shaft position, generating a second estimate of motor torque using the second system to determine current in each motor phase and the second estimate of motor shaft position, comparing the first and second estimates of motor torque for discrepancies, and notifying a motor operator of a potential fault.
